(19) United States
(12) Patent Application Publication
(10) Pub. No.: US 2005/0034744 A1
(43) Pub. Date: Feb. 17, 2005

(54) Rinse solution and methods for forming and cleaning a semiconductor device

(76) Inventor: Il-Hyun Sohn, Suwon-si (KR)

Correspondence Address: HARNESS, DICKEY & PIERCE, P.L.C., P.O. BOX 8910, RESTON, VA, 20195, US

(21) Appl. No.: 10/911,517

(22) Filed: Aug. 5, 2004

(30) Foreign Application Priority Data
Aug. 8, 2003 (KR) 2003-55065

(51) Int. Cl. B08B 3/00

(52) U.S. Cl. 134/26; 134/29; 134/30; 216/39; 216/58; 510/175; 510/176

(57) ABSTRACT

In a method of cleaning a substrate, a photoresist pattern on a substrate is ashed. A remaining photoresist pattern on the substrate is stripped using an organic stripper. The substrate is rinsed using a tetra-methyl ammonium hydroxide (TMAH) rinse solution to remove at least one of an organic stripper, a photoresist pattern, and/or a residual byproduct or polymer, which may be adhered to the substrate. The rinse solution includes about 1 percent by weight to about 30 percents by weight of TMAH, and about 70 percents by weight to about 99 percents by weight of deionized water.

### CROSS REFERENCE TO RELATED APPLICATION

This application claims priority under 35 USC § 119 to Korean Patent Application No. 2003-55065, filed on Aug. 8, 2003, the contents of which are herein incorporated by reference in its entirety.

### BACKGROUND OF THE INVENTION

1. Field of the Invention

The present invention relates to a rinse solution and a method for cleaning a semiconductor device formed on a substrate. More particularly, the present invention may include using a rinse solution to remove an organic stripper, a residual photoresist pattern, and/or a residual byproduct.

2. Description of the Related Art

A semiconductor device manufacturing process may include forming a metal wiring or a contact hole by performing a photolithography procedure. The photolithography procedure may include transcribing a mask pattern onto a photoresist film when forming a photoresist pattern, an etching procedure for forming a layer on a substrate using the photoresist pattern as an etching mask, and a procedure for removing the photoresist pattern and cleaning the substrate.

Removing an entire photoresist pattern and byproducts generated in an etching procedure may require a rapid removal procedure without damaging an underlying layer. The removing procedure may include, for example, a dry strip procedure, an ashing procedure, and/or a wet strip procedure using an organic stripper.

An ashing procedure may remove a substantial portion of a photoresist pattern, however if the ashing fails to remove the entire photoresist pattern, then some of the remaining photoresist pattern and similar byproducts may be removed by a wet strip procedure. The byproducts may be generated for example, in an etching procedure by forming a single wiring pattern or a multi-layered pattern including one or more of tungsten, titanium, aluminum, copper and/or titanium nitride. The byproducts may also be generated by an etching or ashing procedure, for example when forming a via hole or a bonding pad hole and exposing the wiring pattern. The byproducts may include a polymer, which may be generated by a plasma etching procedure or a reactive ion etching (RIE) procedure.

A cleaning procedure may be provided, for example by using an organic stripper, after the wet strip procedure. An organic stripper containing deionized water may cause corrosion and/or other damage to a wiring pattern. Therefore, rinsing the wiring pattern using an isopropyl alcohol (IPA) solution may reduce the chances that corrosion and/or other damage of the wiring pattern occur.

FIG. 1 is a flow chart illustrating a conventional method of cleaning a substrate using a rinse solution when forming a hole through a bonding pad of a substrate.

Referring to FIG. 1, S1 for instance, provides an insulating layer formed on a substrate, on which a bonding pad may also be formed. The insulating layer may include an oxide layer and/or a nitride layer. In S2, a photoresist pattern may be formed on the insulating layer by a photolithography procedure.

In S3, the insulating layer may be dry etched, using the photoresist pattern as an etching mask, to form a hole through the insulating layer. The dry etching procedure may include a plasma etching procedure or a RIE procedure, and may be carried out using a gas mixture including one or more of carbide, sulfide and/or fluoride. The photoresist pattern may contain for example, carbon, hydrogen and/or oxygen, which may be combined with plasma in the dry etching procedure to form a polymer on the bonding pad.

In S4, the photoresist pattern may be removed by an ashing procedure, which may include plasma and/or an oxygen gas. In S5, the remaining photoresist pattern and byproducts including a polymer, may be removed by using an organic stripper.

In S6, the substrate may be rinsed using an IPA solution to remove the organic stripper, and in S7 the substrate may be rinsed using deionized water. In S8, the deionized water may then be dried, and in S9, the remaining polymer may be removed by performing an additional ashing procedure.

The polymer may corrode the bonding pad, which may cause the bonding pad may to have a high contact resistance, thus causing a bonding pad failure to occur.

The conventional method for cleaning a substrate may not entirely remove a residual byproduct, thus leaving a portion of the residual byproduct behind. Therefore, an additional ashing procedure for removing the remaining polymer may be needed to clean the left over polymer. However, an additional ashing procedure may cause a decrease in productivity and/or an increase in cost. Additionally, removing a residual byproduct by performing an additional ashing procedure may cause discoloration of the surface of the bonding pad.

### SUMMARY OF THE INVENTION

The exemplary embodiments of the present invention provide a rinse solution that may remove an organic stripper, a residual photoresist pattern, and/or a residual byproduct, which may have been generated in a stripping procedure, where the residual byproduct may be a polymer.

The exemplary embodiments of the present invention may also provide a method of cleaning a substrate using a rinse solution.

An exemplary embodiment of the present invention may provide a rinse solution for removing at least one of an organic stripper, a residual photoresist pattern, and/or a residual byproduct. The rinse solution may include about 1 percent to 30 percent by weight, of tetra-methyl ammonium hydroxide (TMAH), and about 70 percent to 99 percent by weight, of deionized water.

Another exemplary embodiment of the present invention may provide a method of cleaning a substrate using a rinse solution. The cleaning may include an ashing operation for removing a photoresist pattern on a substrate. The photoresist pattern may also be removed using an organic stripper by performing a stripping operation. The substrate may then be rinsed using a TMAH solution to remove at least one of the organic stripper, a residual photoresist pattern, and/or a residual byproduct, which may be adhered to the substrate.

Another exemplary embodiment of the present invention may provide a method of cleaning a substrate using a rinse solution. The method may include performing an ashing operation on a photoresist pattern of the substrate to remove the photoresist pattern. The photoresist pattern may also be removed using an organic stripper by performing a stripping operation. The substrate may be rinsed using a TMAH solution to remove at least one of the organic stripper, a residual photoresist pattern, and/or a residual byproduct, which may be adhered to the substrate. The substrate may also be rinsed using deionized water, and dried to remove the deionized water.

Another exemplary embodiment of the present invention may provide a method for forming a hole on a bonding pad of a semiconductor device of a substrate. An insulating layer may be formed on the bonding pad, and a photoresist pattern may be formed on the insulating layer. The insulating layer may be dry etched using the photoresist pattern as an etching mask to form a hole in the insulating layer. The photoresist pattern may be ashed to remove the photoresist pattern. The photoresist pattern may be stripped using an organic stripper. The substrate may then be rinsed using a TMAH solution to remove at least one of the organic stripper, a residual photoresist pattern, and/or a residual byproduct. The substrate may be rinsed using deionized water, and dried to remove the deionized water.

### BRIEF DESCRIPTION OF THE DRAWINGS

The present invention will become more apparent to those of ordinary skill in the art by describing, in detail, exemplary embodiments thereof with reference to the attached drawings, wherein like elements are represented by like reference numerals, which are given by way of illustration only and thus do not limit the exemplary embodiments of the present invention.

FIG. 1 is a flow chart illustrating a conventional method of cleaning a substrate using a rinse solution when forming a hole on a bonding pad of the substrate;

FIG. 2 is a flow chart illustrating a method of cleaning a substrate using a rinse solution when forming a contact hole through an insulating layer of the substrate, according to an exemplary embodiment of the present invention;

FIG. 3 is a flow chart illustrating a method of cleaning a substrate using a rinse solution when forming a hole on a bonding pad of the substrate, according to an exemplary embodiment of the present invention; and

FIGS. 4A to 4F are cross sectional views illustrating a method of forming a hole through a bonding pad of a substrate, according to an exemplary embodiment of the present invention.

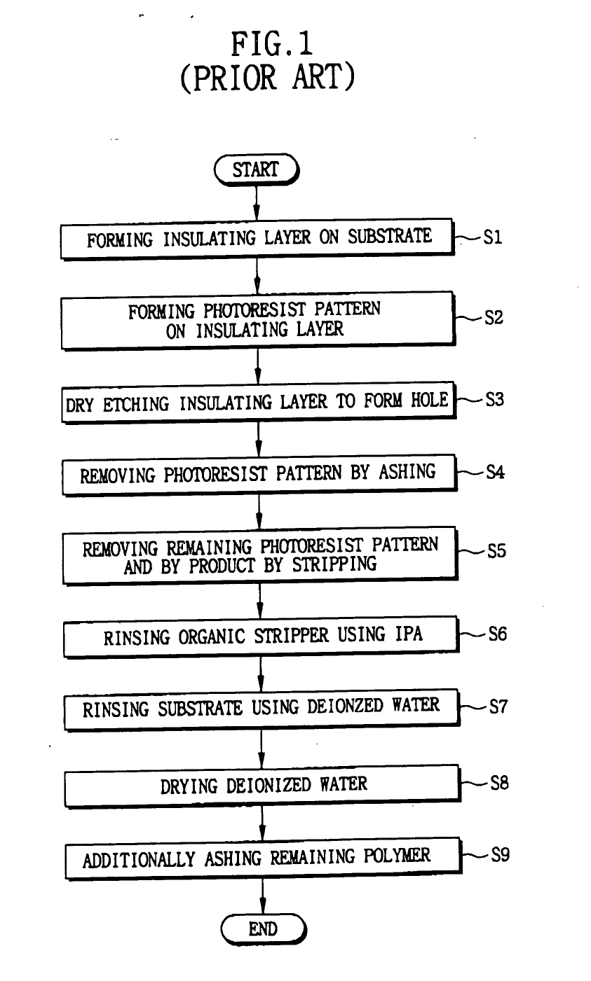

### DETAILED DESCRIPTION OF THE EXEMPLARY EMBODIMENTS OF THE PRESENT INVENTION

The present invention now will be described more fully hereinafter with reference to the accompanying drawings, in which exemplary embodiments of the invention are shown. It should be understood, however, that exemplary embodiments of the present invention described herein can be modified in form and detail without departing from the spirit and scope of the invention. Accordingly, the exemplary embodiments described herein are provided by way of example and not of limitation, and the scope of the present invention is not restricted to the particular embodiments described herein. Like numbers refer to similar or identical elements throughout.

In particular, the relative thicknesses and positioning of layers or regions may be reduced or exaggerated for clarity. Further, a layer is considered as being formed “on” another layer or a substrate when formed either directly on the referenced layer or the substrate or formed on other layers or patterns overlaying the referenced layer.

A rinse solution, in accordance with an exemplary embodiment of the present invention, may be used for removing an organic stripper, a residual photoresist pattern, and/or a residual byproduct, where the residual byproduct may be a polymer. A rinse solution may include for example, about 1 percent to about 30 percent by weight, of tetra-methyl ammonium hydroxide (TMAH), and about 70 percent to about 99 percent by weight, of deionized water.

The rinse solution may remove an organic stripper, which may be used for removing a photoresist pattern used in an etching procedure, and/or a residual byproduct, which may be generated in the etching procedure.

Table 1 provides an example of four substrates with corresponding bonding pads formed on the substrates, respectively. Additionally, the four substrates 1-4 may include an oxide layer formed, a nitride layer formed on the oxide layer, and/or a photoresist pattern formed on the nitride layer.

The nitride layer and the oxide layer of the four substrates may be etched using the photoresist pattern as an etching mask, when forming a hole in one or more layers on the substrate.

An ashing operation may be performed on the photoresist pattern of the four substrates. The substrates 1-4 (illustrated in the example of Table 1) were stripped using an organic solution or stripper, to remove a partial photoresist pattern. The organic stripper used for this particular example, may be an SMS50L manufactured by Dongwoo Fine Chemical Corporations, however the stripping operation may be performed using other types of organic stripper.

The substrates may be dipped in separate baths, each containing a different rinse solution as shown in Table 1, in order to remove an organic stripper, a residual photoresist pattern and/or a residual byproduct or polymer, from the substrates. Table 1 illustrates the removal of a polymer from a corresponding substrate for various types of different rinse solutions, however, the rinse solutions are not limited to the removal of polymers, and may be used to remove other types of substances including, for example, an organic stripper, a residual photoresist pattern and/or a residual byproduct.

TABLE 1

| Substrate | Rinse solution | Effect of removing polymer |
|---|---|---|
| No. 1 | TMAH | G |
| No. 2 | DMAC | I |
| No. 3 | MMP | B |
| No. 4 | IPA | I |

In accordance with the example rinsing operations illustrated in Table 1, substrate No. 1 for example, was dipped in a bath containing about 2.72 percent of TMAH solution by weight. Substrate No. 2 was dipped in a bath containing dimethyl acetamide (DMAC) solution, substrate No. 3 was dipped in a bath containing methyl methoxy propionate (MMP) solution, and substrate No. 4 was dipped in a bath containing isopropyl alcohol (IPA) solution.

For the example illustrated in Table 1, all of the baths had a temperature of about 25° C., and the rinsing time of substrate No. 1 was about 70 seconds, and about 150 seconds for substrate Nos. 2-4.

The substrates 1-4 of Table 1, were rinsed using deionzed water, and were dried to remove the deionzed water. The effects of the removal procedure used to remove the polymer in substrates 1-4 was measured using inspection equipment, which calculated the amounts of residual byproduct or polymer left on the substrates 1-4.

In Table 1, “G” represents a good condition result, “B” represents a bad condition result and “I” represents a very bad condition result for the amount of residual byproduct or polymer left on the substrates 1-4 based on the measurements. The very bad condition “I” may indicate that an additional ashing procedure might be needed. As shown in Table 1, it is noted that the TMAH solution effectively removed more polymer when compared to the other rinse solutions.

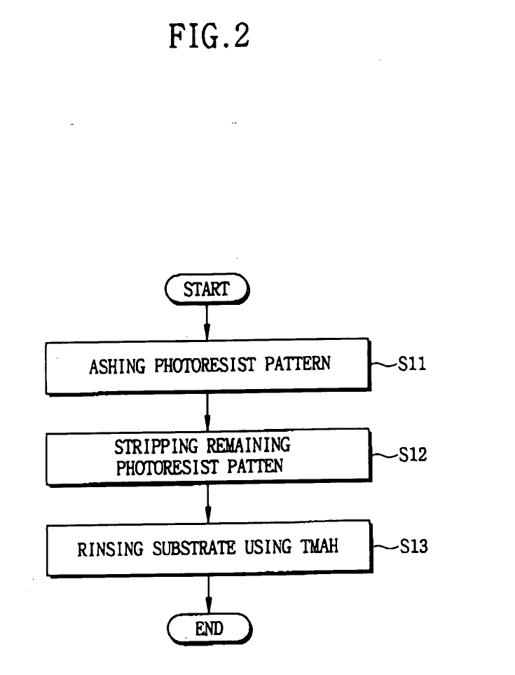

FIG. 2 is a flow chart illustrating a method of cleaning a substrate using a rinse solution, when forming a contact hole through an insulating layer of the substrate, according to an exemplary embodiment of the present invention.

Referring to FIG. 2, in S11, a photoresist pattern on a substrate may be ashed, leaving a partial photoresist pattern behind. In S12, the remaining photoresist pattern may be stripped using an organic stripper.

The substrate may be rinsed using a TMAH solution to remove an organic stripper, a residual photoresist pattern, and/or byproducts, which may be generated by an etching procedure. If the organic stripper contacts the deionized water, the bonding pad may become corroded and/or damaged, thus by removing the organic stripper, the residual photoresist pattern, and/or other residual byproducts using the TMAH solution, the chances of corrosion or damage to the bond pad may be reduced.

The TMAH solution may include about 1 percent to about 30 percent, by weight of TMAH, and about 70 percent to about 99 percent, by weight of deionized water. The substrate may be dipped in a bath containing a TMAH solution, or the TMAH solution may be sprayed on the substrate. Rinsing may be performed on the substrate at a temperature of about 10° C. to about 50° C., and for a duration of about 1 second to about 600 seconds.

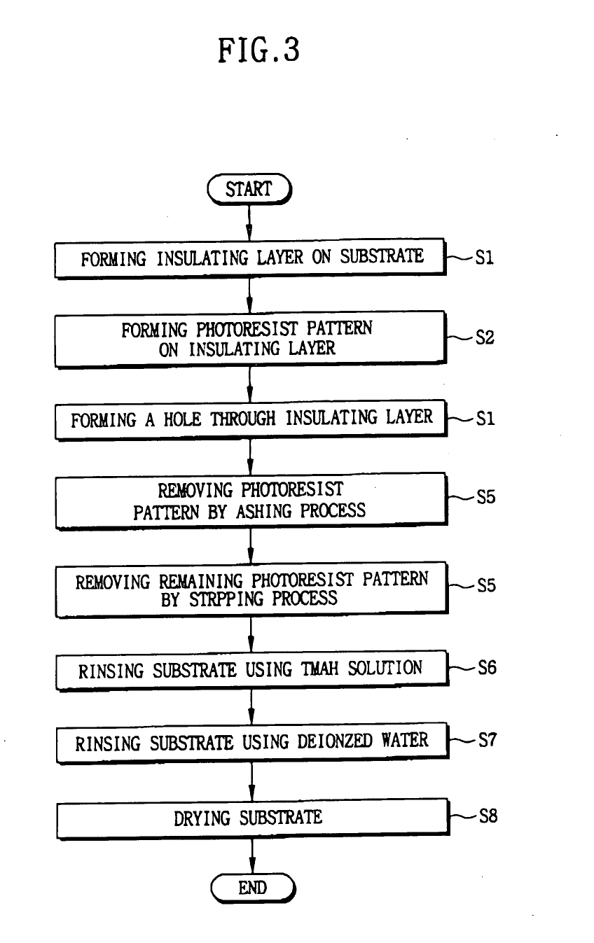

FIG. 3 is a flow chart illustrating a method of cleaning a substrate using a rinse solution when forming a hole for a bonding pad of a substrate, in accordance with an exemplary embodiment of the present invention.

Referring to FIG. 3, in S21, an insulating layer and a bonding pad may be formed on a substrate. The insulating layer may be composed of an oxide layer and/or a nitride layer, and in S22 a photoresist pattern may be formed on the insulating layer.

In S23, the insulating layer may be dry etched using the photoresist pattern as an etching mask to form a hole. The dry etching may be carried out for example, by using plasma etching or RIE, which may include a mixture of gas for example, carbide, sulfide and/or fluoride. A carbon-containing polymer may be formed when plasma, which may be used from the dry etching procedure, reacts with one or more of carbon, hydrogen and/or oxygen, which may be in the photoresist pattern. The reaction may cause the dry etching procedure to form a carbon-containing polymer on the bonding pad.

In S24, an ashing procedure may be performed on the substrate, which may include using an oxygen-containing plasma, to remove the photoresist pattern. In S25, a stripping procedure may be peformed on the substrate using an organic stripper to remove the remaining photoresist pattern after the ashing procedure has been performed.

In S26, the substrate may be rinsed using a TMAH solution to remove the organic stripper, a residual photoresist pattern, and/or a residual byproduct, which may be generated in the etching procedure. If the organic stripper of the substrate makes direct contact with deionized water, the bonding pad may become corroded and/or damaged. Therefore, the TMAH solution may reduce the chances of the bonding pad being damaged for example, by removing the organic stripper, a residual photoresist pattern and/or a residual byproduct.

Other forms of cleaning the substrate with the TMAH solution may include for example, dipping the substrate in a bath containing the TMAH solution and/or spraying the TMAH solution onto the substrate. The rinse procedure for example, may be performed on the substrate at a temperature of about 10° C. to about 50° C., and for a duration of about 1 second to about 600 seconds.

In S27, the substrate may be rinsed using deionized water. In S28, the substrate may be dried using, for example, an IPA solution to remove the deionized water.

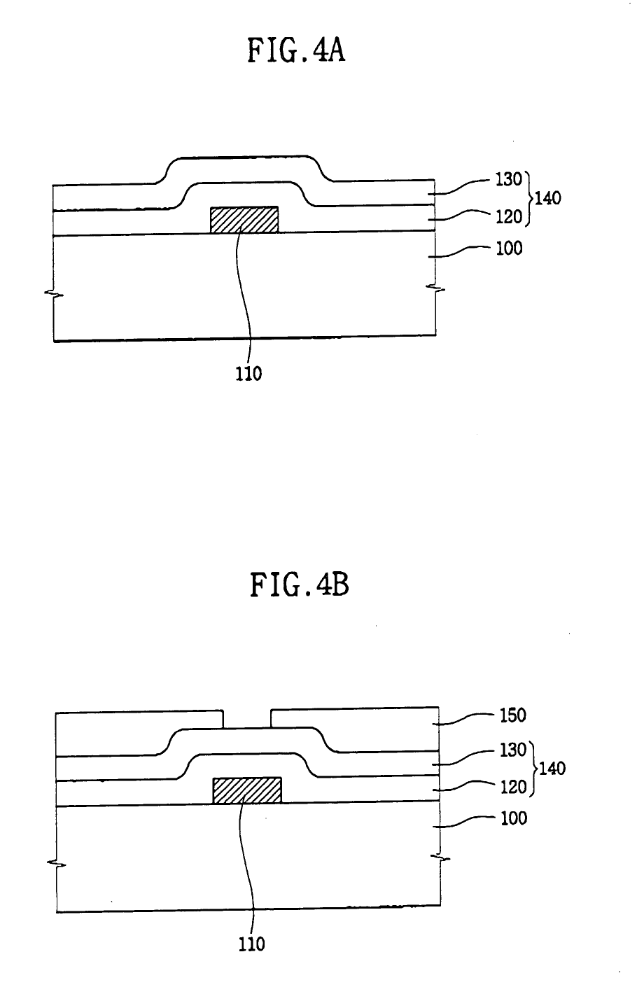

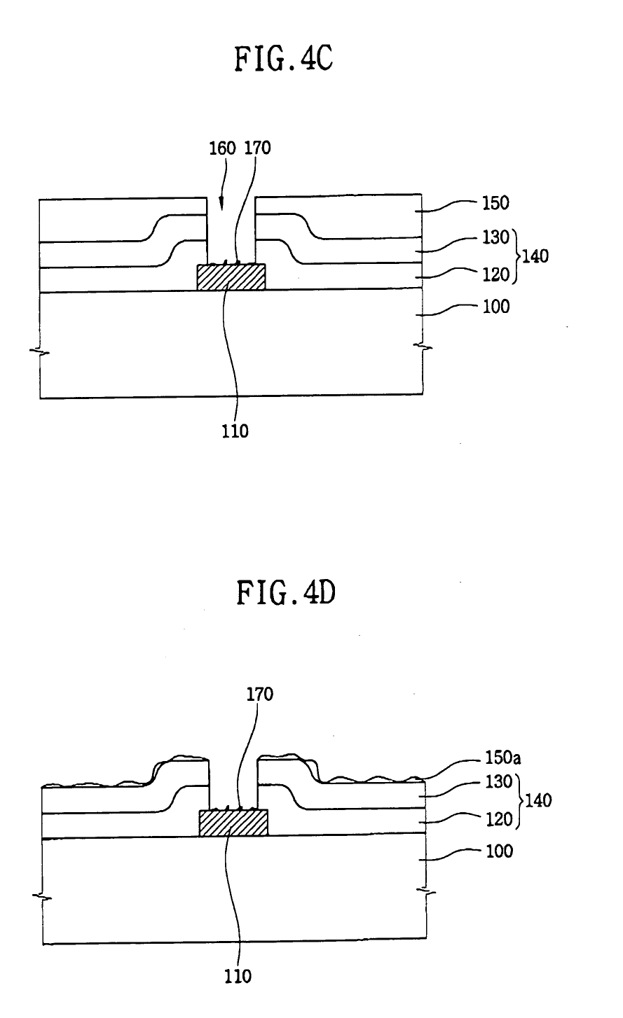

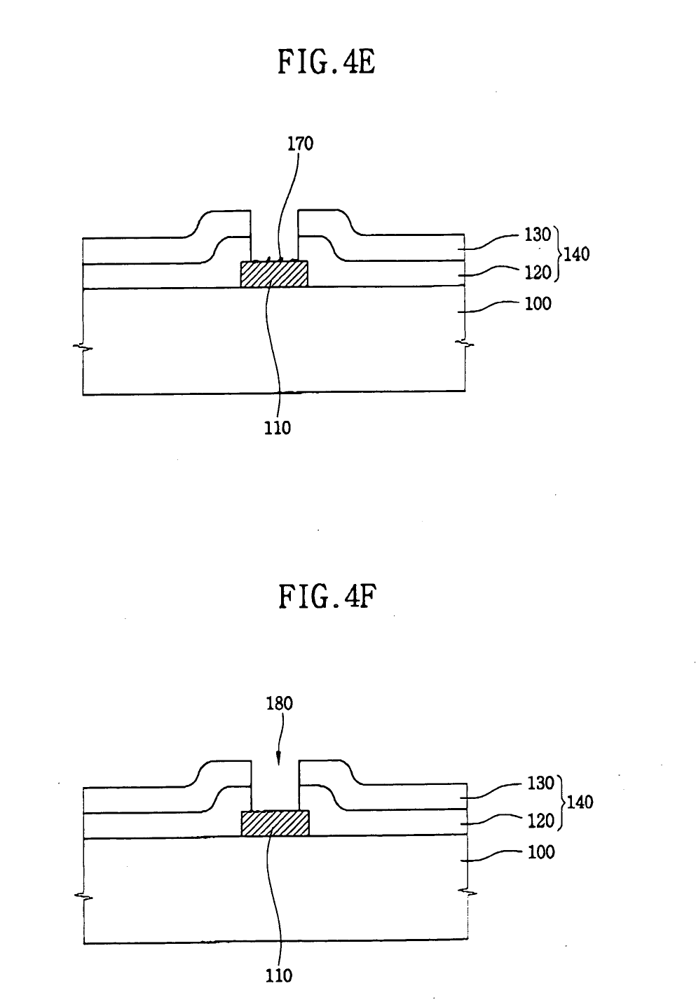

FIGS. 4A to 4F are cross sectional views illustrating a method of forming a hole through a bonding pad of a substrate, in accordance with an exemplary embodiment of the present invention.

Referring to FIG. 4A, a bonding pad 110 may be formed on a substrate 100. An insulating layer 140 may be formed on the bonding pad 110 and the substrate 100. The insulating layer 140 may include an oxide layer 120 and a nitride layer 130, where the oxide layer 120 may be formed on the bonding pad 110 and the substrate 100, and the nitride layer 130 may be formed on the oxide layer 120.

Referring to FIG. 4B, a photoresist pattern 150 may be formed on the insulating layer 140. In particular, a photoresist film may be formed on the insulating layer 140. The photoresist film may be exposed allowing a mask pattern to be transcribed into the photoresist film. A development procedure may be performed for partially removing some of the photoresist pattern to form the photoresist pattern 150 on the bonding pad 110, as illustrated in FIG. 4B.

Referring to FIG. 4C, the insulating layer 140 may be dry etched to form a preliminary hole 160 exposing the bonding pad 110, using the photoresist pattern 150 as an etching mask.

The dry etching procedure may be performed, for example, by using plasma etching or RIE, which may include a gas mixture for example, containing one or more of, carbide, sulfide and/or fluoride. A carbon-containing polymer may be formed when plasma, which may be used in the dry etching procedure, reacts with one or more of carbon, hydrogen and/or oxygen, which may be in the photoresist pattern. The reaction may cause the dry etching procedure to form a carbon-containing polymer on the bonding pad 110.

Referring to FIG. 4D, according to an exemplary embodiment of the present invention, the photoresist pattern 150 may be ashed using oxygen-containing plasma. After the photoresist pattern 150 is ashed, the photoresist pattern 150 may not have been removed entirely, thus a portion 150a of the original photoresist pattern 150 may still remain on the insulating layer 140.

Referring to FIG. 4E, according to an exemplary embodiment of the present invention, the remaining photoresist pattern 150a may be stripped using an organic stripper.

Referring to FIG. 4F, according to an exemplary embodiment of the present invention, the substrate 100 may be rinsed using a TMAH rinse solution to remove the organic stripper, a residual photoresist pattern and/or a residual byproduct, for example polymer 170, to reduce the chances of corrosion of the bond pad 110. Therefore, a hole 180 may be formed through the insulating layer 140 without the polymer 170.

The substrate 100, according to an exemplary embodiment of the present invention, may be rinsed using deionzied water to remove the TMAH rinse solution from the substrate 100. The substrate 100 may be dried using an IPA solution to remove the deionzied water.

As described above, in the exemplary embodiments of the present invention, the organic stripper, a residual photoresist pattern and/or a residual byproduct or polymer, may be removed using the TMAH rinse solution. Therefore, forming a hole through the insulating layer(s), may be performed without leaving behind an organic stripper, a residual photoresist pattern and/or a residual byproduct or polymer.

As described in the exemplary embodiments of the present invention included in this detailed description, a TMAH solution has been described as being used for removing one or more of an organic stripper, a residual photoresist pattern, and/or a residual byproduct. In addition to the TMAH solution, it will be recognized that other types of solutions may be used for removing an organic stripper, a residual photoresist pattern and/or a residual byproduct, for example, other types of ammonium hydroxide or similar solutions may be recognized as an alternative for TMAH, and which may be used by cleaning and/or removal procedures disclosed herein.

As a result of using the TMAH solution, an additional ashing procedure may not be required, thus the productivity and/or cost considerations associated with a semiconductor device may be improved. Also, the likelihood of that a bonding pad surface becomes discolored may be reduced.

While this invention has been particularly shown and described with reference to exemplary embodiments thereof, it will be understood by those skilled in the art that various changes in form and details may be made therein without departing from the spirit and scope of the invention as defined by the following claims.

1. A rinse solution for removing at least one of an organic stripper, a residual byproduct and a residual photoresist pattern comprising:
about 1 percent to about 30 percent by weight of tetra-methyl ammonium hydroxide (TMAH); and
about 70 percent to about 99 percent by weight of deionized water.

2. The rinse solution of claim 1, wherein the residual byproduct is a polymer.

3. A method of cleaning a substrate comprising:
ashing a photoresist pattern on a substrate;
stripping the photoresist pattern on the substrate using an organic stripper; and
rinsing the substrate using a tetra-methyl ammonium hydroxide (TMAH) rinse solution to remove at least one of the organic stripper, a residual byproduct and a residual photoresist pattern, adhered to the substrate.

4. The method of claim 3, wherein the TMAH rinse solution includes about 1 percent to about 30 percent by weight of tetra-methyl ammonium hydroxide (TMAH), and about 70 percent to about 99 percent by weight of deionized water.

5. The method of claim 3, wherein rinsing the substrate includes dipping the substrate in the TMAH rinse solution.

6. The method of claim 3, wherein rinsing the substrate includes spraying the TMAH rinse solution onto the substrate.

7. The method of claim 3, wherein the substrate is rinsed at a temperature of about 10° C. to about 50° C.

8. The method of claim 3, wherein the substrate is rinsed for a duration of about 1 second to about 600 seconds.

9. The method of claim 3, wherein the residual byproduct is a polymer.

10. A method of cleaning a substrate comprising:
ashing a photoresist pattern on a substrate;
stripping the photoresist pattern using an organic stripper;
rinsing the substrate using a tetra-methyl ammonium hydroxide (TMAH) rinse solution to remove at least one of an organic stripper, a residual byproduct and a residual photoresist pattern, adhered to the substrate;
rinsing the substrate using deionzied water; and
drying the substrate to remove the deionized water.

11. The method of claim 10, wherein the TMAH rinse solution includes about 1 percent to about 30 percent by weight of tetra-methyl ammonium hydroxide (TMAH), and about 70 percent to about 99 percent by weight of deionized water.

12. The method of claim 10, wherein rinsing the substrate includes dipping the substrate in the TMAH rinse solution.

13. The method of claim 10, wherein rinsing the substrate includes spraying the TMAH rinse solution onto the substrate.

14. The method of claim 10, wherein the substrate is rinsed at a temperature of about 10° C. to about 50° C.

15. The method of claim 10, wherein the substrate is rinsed for a duration of about 1 second to about 600 seconds.

16. A method of forming a hole through a bonding pad of a semiconductor device comprising:
forming a bonding pad on a substrate;
forming an insulation layer on the bonding pad and the substrate;
forming a photoresist pattern on the insulation layer;
dry etching the insulation layer using the photoresist pattern as an etching mask to form a hole exposing the bonding pad;
ashing the photoresist pattern;
stripping the photoresist pattern using an organic stripper;
rinsing the substrate using a tetra-methyl ammonium hydroxide (TMAH) rinse solution to remove at least one of an organic stripper, a residual byproduct and a residual photoresist pattern, adhered to the substrate;
rinsing the substrate using deionzied water; and
drying the substrate to remove the deionized water.

17. The method of claim 16, wherein the TMAH rinse solution includes about 1 percent to about 30 percent by weight of tetra-methyl ammonium hydroxide (TMAH) and about 70 percent to about 99 percent by weight of deionized water.

18. The method of claim 16, wherein the insulation layer includes an oxide layer, a nitride layer or an oxide/nitride layer.

19. The method of claim 16, wherein ashing the photoresist pattern includes using an oxygen-containing plasma to remove the photoresist pattern.

20. The method of claim 16, wherein drying the substrate includes using an isopropyl alcohol solution to remove the deionized water.

21. The method of claim 16, wherein the residual byproduct is a polymer.
